(19) United States
(12) Patent Application Publication
(10) Pub. No.: US 2004/0020111 A1
(43) Pub. Date: Feb. 5, 2004

(54) Planter security barricade system (PSBS)

(76) Inventor: Ben Vandenbossche, Carson City, NV (US)

Correspondence Address: BEN VANDENBOSSCHE, 2900 LOCKHEED WAY, CARSON CITY, NV, 89706, US

(21) Appl. No.: 10/429,782

(22) Filed: May 6, 2003

Related U.S. Application Data
(60) Provisional application No. 60/380,150, filed on May 7, 2002.
(60) Provisional application No. 60/379,641, filed on May 13, 2002.
(60) Provisional application No. 60/380,149, filed on May 7, 2002.

(51) Int. Cl. A01G 23/10

(52) U.S. Cl. 47/10

(57) ABSTRACT

The Planter Security Barricade System or PSBS is a lightweight decorative planter with pre-engineered interior barrier form and steel rebar caging. The planter and interior barrier are made of glass fiber reinforced concrete, a proprietary compound of graded stone and cement reinforced with long-strand alkaline resistant glass fibers. The result is a composite that combines the strength and lightweight characteristics of conventional fiberglass with the durability and longevity of cast stone. Specifically, the planter barricade consist of: 1) an outer planter shell made of composite cement and graded stone embedded with strands of glass fibers; 2) a pre-engineered barrier form that has an upwardly extending narrow wall portion and a wide base lower portion; and 3) a standard rebar caging design consisting of a plurality of L-shaped standard grade steel rebar assembled to a cross-member from the top and middle portions.

### CROSS-REFERENCE TO RELATED APPLICATION

This application is related to my co-pending patent applications, namely:

1) “Modular Exterior Casing for Crash Barriers made of Glass Fiber Reinforced Concrete” (Serial No. 60/380,150 filed May 7, 2000);

2) “Dirt Retaining Wall Barrier” (Serial No. 60/379,641 filed May 13, 2002).

Other co-pending applications, the serial numbers of which are yet to be assigned, are also related, particularly:

1) “Magnum FP Planter Barrier”

2) “Pre-engineered and pre-finished Concrete Jersey Barrier Skin made of Composite Cement Embedded with Strands of Glass Fibers”

### FIELD OF INVENTION

This invention relates to composite cement planters, particularly lightweight protective and decorative planter barricades made of glass fiber reinforced concrete with pre-engineered barrier form and steel rebar caging.

### BACKGROUND OF INVENTION AND PRIOR ART

Whereas, U.S. Patent Application No. 20020139047 of Haddad, Joseph Francis; et al. relates to certain container type products, specifically planters consisting of four or more sides and a bottom, and post caps consisting of four sides and a lid. This invention provides for constructing said products by joining components that are milled from composite wood extruded stock using conventional wood milling methods. Products so constructed possess present wood or plastic commercial products. A joining method for the component parts that employs dove-tailed grooves and channels and requires no adhesives, nails or other fastening devices is provided.

Whereas, U.S. Pat. No. 6,360,484 to Kreizel is a decorative planter that includes a base having upper and lower portions and a flange disposed about the outer periphery of the upper portion. The planter also includes a collar dimensioned to encompass the upper portion of the base. The collar has a mechanical interface which engages the flange such that the collar and the flange form a decorative rim about the upper portion of the planter.

Whereas, U.S. Pat. No. 6,357,179 to Buss refers to a self-watering planter having a container and a floor structure. The latter includes one or more troughs that extend downwardly from floor. When manufacture of the planter is complete, a chamber portion for receiving planting medium is provided above the floor. This chamber portion includes interior regions of the troughs. A lower chamber portion is provided beneath the floor structure for receiving water. Openings in bottom ends of troughs permit water in the lower chamber portion to be wicked up into the planting medium in the troughs, which in turn is wicked up into planting medium in upper portions of the upper chamber portion. The planter is designed to be manufactured with a single mold in a single molding operation.

Whereas, U.S. Pat. No. 6,442,895 to Van Roey relates to an internal construction device for assembling a plant from a plurality of smaller plants, the device comprising a support pole which extends in the height direction of the construction, and a plurality of superimposed retainers applied around the support pole and nested within each other, the retainers being provided for receiving dirt and plants. A retainer underneath comprises a side wall and a top face; a subsequent retainer comprises a side wall and a bottom face. The top face of the retainer underneath has a larger surface area than the bottom face of the subsequent retainer so as to create, between the side walls of both retainers, a space for receiving plants. The retainer is a casing having a side wall, top face and bottom, the top and bottom faces being substantially open. The casing is connected to the support pole.

Whereas, U.S. Pat. No. 5,741,339 to DuMars, et al. provides a built-in cantilevered open topped hollow to allow for the diverse advantage of planted foliage on new or pre-existing vertical wall constructs.

### SUMMARY OF THE INVENTION

The Planter Security Barricade System (hereinafter referred to as PSBS) is a lightweight decorative planter with pre-engineered interior barrier form and steel rebar caging. The planter and interior barrier are made of glass fiber reinforced concrete, a proprietary compound of graded stone and cement reinforced with long-strand alkaline resistant glass fibers. The result is a composite that combines the strength and lightweight characteristics of conventional fiberglass with the durability and longevity of cast stone.

Most commonly known barricades are Jersey shape barriers used as temporary road dividers for a construction or permanently for separating traffic lanes for roadways. This barrier is also employed to control access to entranceways, driveways and to secure perimeter areas around buildings and objects requiring protection. This barricade type is composed of a plurality of such barrier elements successively arranged in a row. In case of collision, they will therefore act as a solid wall with no possibility of soft absorption of the collision forces. Owing to their great mass per unit of length, such barrier elements are expensive to buy and time-consuming to mount.

Unlike conventional concrete, the novel characteristic of this invention is found in its material that holds the composite elements together because of fibers randomly dispersed and laid in all directions within the material matrix. In addition to its higher impact resistance, PSBS glass fiber reinforced concrete has a ductile behavior where damage due to impact is usually confined to the area of impact without propagating. The impact resistance therefore is influenced mainly by the reinforcing fibers. In contrast, conventional concrete has the trait known as ‘brittle failure’ because it has semi-crystalline structures that tend to shatter on impact. This is especially dangerous when subjected to explosive force because ballistic debris is created which can create significant collateral damage. PSBS dramatically reduces ballistic debris.

Recent concepts led to new and emerging -functions of concrete barriers. Planter barricades with three-dimensional shapes are among the novel proposals that now find a new place in the market. Other than its unique composite material, the present invention is an improvement over prior proposals, in that is relies on a system comprising of three layers of construction, namely, an outer planter that comes with a wide variety of three-dimensional shapes and sizes, a pre-engineered second layer barrier form and a rebar caging reinforcement.

This invention differs with a co-pending application entitled “Modular Exterior Casing for Crash Barriers made of Glass Fiber Reinforced Concrete”, serial No. 60/380,150 filed May 7, 2002, in that the latter provides an exterior casing to cover existing concrete barriers, particularly jersey shape barriers. It does not have steel-reinforcing bars and graded rock aggregates necessary for installation. It is modular in construction designed to fit generally any type of concrete shape barriers as it virtually expands in all directions. Its three-dimensional shape is limited to a plurality of lumps or bull nose designs surrounding the lateral and longitudinal wall segments that are slightly sloped about 75 to 85 degrees oblique from the base recessed wall.

Other related applications are the “Magnum FP Planter Barrier” and “Pre-engineered and pre-finished Concrete Jersey Barrier Skin made of Composite Cement Embedded with Strands of Glass Fibers” (hereinafter referred to as the Jersey Barrier Skin).

The Magnum FP Planter Barrier requires at least 18-inch depth surface trenching. It has a planting compartment with a chamfered base design from the backside supported by similarly inclined rebar underneath. Said chamfered lower back surface is designed to provide a slanting angle intended to deflect force of an impacting vehicle thereby generating progressive resistance. The rebar caging design is complex compared to the PSBS that is situated in the interior. The Magnum FP Planter Barrier rebar is layered between the outer planter shell and the planting compartment.

The Jersey Barrier Skin is a modular enclosure for Jersey shaped barriers consisting of elongated wall portions and short-side wall portions with an extended crown and ceiling. The crown corresponds the elongated wall portion symmetrical to the end-sides. It utilizes intermittent and continuous steel channel attachments against pre-cast concrete barriers. The crown ceiling extends slightly overhanging the base wall above an inverse curve surface design.

### OBJECTS OF THE INVENTION

Accordingly, the objects and novel characteristic of the present invention are:

1) to provide a barricade system consisting of decorative planter elements that comes with a variety of three-dimensional shapes and sizes;

2) to provide a barricade system with pre-engineered barrier form that has an upwardly extending wall portion and lower base portion. The top and bottom sections provide an opening intended for back fill of commercial grade cement and optional metal pin dowel reinforcement;

3) to provide a barricade system with a standard rebar caging design.

Other objects of the invention will become apparent from a consideration of the drawings and subsequent description.

### DESCRIPTION OF DRAWINGS

In the drawings, reference numerals are supplied for purposes of detailed discussion. Related drawings or figures are suffixed in alphabetical order. To understand the range of planter configurations, tables of shape and dimension were included following each planter barricade design. A planter design is identified with a designated series or title for purposes of classification, example: Round, Broadway or Florence.

FIG. 1 shows a plan view of cylindrical shaped planter surrounding a pre-engineered barrier form. FIG. 1-A shows a plan view of square shaped planter surrounding a pre-engineered barrier form. FIG. 1-B shows a plan view of rectangular shaped planter surrounding a pre-engineered barrier form.

FIG. 2 provides an elevational view of a planter with three-dimensional shape wherein said decorative element may come in a variety of design, finish and sizes, depending on site specification. FIG. 2-A reveals a section view of a planter showing a partial elevation of the barrier form slightly lower from the tip of a decorative planter. FIG. 2-B provides a modified view of a planter with a hidden barrier form and rebar caging shown from the end-side represented by broken lines. FIG. 2-C is a section view of a planter illustrating randomly dispersed strands of glass fibers laid within the material matrix. FIGS. 2-D, 2-E and 2-F are tables of dimensions, weights and capacities indicating the diameter, overall height, base and side dimension of the Paseo cylinder, square and rectangle shapes.

FIG. 3 is a plan view of the barrier form without the decorative planter. FIG. 3-A is a modified elevational view of the barrier form with an upwardly extending wall portion and lower base portion. Section shows a barrier form with glass fibers randomly dispersed and lay within the internal matrix. FIG. 3-B is a section view of the barrier from the end-side illustrating the lower base portion that is wide and an upwardly extending wall portion narrower than the base. FIG. 3-C is an end-side section of the barrier form disclosing a rebar caging as exposed;

FIG. 4 is an isometric view of the rebar caging design representing a plurality of L-shaped standard grade steel bars attached to a series of cross-members from the top and mid portion.

FIG. 5 is a planter barricade security system identified as the Broadway series. FIGS. 5-A, 5-B and 5-C are tables of dimensions, weights and capacities indicating the diameter, overall height, base and side dimension of the Broadway cylinder, square and rectangle shapes.

FIG. 6 is a planter barricade security system identified as the Centurion series. FIGS. 6-A, 6-B and 6-C are tables of dimensions, weights and capacities indicating the diameter, overall height, base and side dimension of the Centurion cylinder, square and rectangle shapes.

FIG. 7 is a planter barricade security system identified as the Florence series. FIGS. 7-A, 7-B and 7-C are tables of dimensions, weights and capacities indicating the diameter, overall height, base and side dimension of the Florence cylinder, square and rectangle shapes.

FIG. 8 is a planter barricade security system identified as the Mezzo series. FIGS. 8-A, 8-B and 8-C are tables of dimensions, weights and capacities indicating the diameter, overall height, base and side dimension of the Mezzo cylinder, square and rectangle shapes.

FIG. 9 is a planter barricade security system identified as the Nastello series. FIGS. 9-A, 9-B and 9-C are tables of dimensions, weights and capacities indicating the diameter, overall height, base and side dimension of the Nastello cylinder, square and rectangle shapes.

FIG. 10 is a planter barricade security system identified as the Tuscan series. FIGS. 10-A, 10-B and 10-C are tables of dimensions, weights and capacities indicating the diameter, overall height, base and side dimension of the Tuscan cylinder, square and rectangle shapes.

FIG. 11 is a planter barricade security system identified as the Vineto series. FIGS. 11-A, 11-B and 11-C are tables of dimensions, weights and capacities indicating the diameter, overall height, base and side dimension of the Vineto cylinder, square and rectangle shapes.

FIG. 12 is a planter barricade security system identified as the Jordache series. FIGS. 12-A, 12-B and 12-C are tables of dimensions, weights and capacities indicating the diameter, overall height, base and side dimension of the Jordache cylinder, square and rectangle shapes.

FIG. 13 is a planter barricade security system identified as the Quattro series. FIGS. 13-A and 13-B are tables of dimensions, weights and capacities indicating the diameter, overall height, base and side dimension of the Quattro square and rectangle shapes.

FIG. 14 is a planter barricade security system identified as the Round series. FIG. 14-A is a table of dimensions, weights and capacities indicating the diameter, overall height and base dimension of the Round cylinder shapes.

FIG. 15 is a planter barricade security system identified as the Square series. FIGS. 15-A and 15-B are tables of dimensions, weights and capacities indicating the diameter, overall height, base and side dimension of the Square rectangle and square shapes.

FIG. 16 is a planter barricade security system identified as the Grecian series. FIG. 16-A is a table of dimensions, weights and capacities indicating the diameter, overall height, base and side dimension of the Grecian cylinder shapes.

REFERENCE NUMERALS IN DRAWINGS

| | |
|---|---|
| 18 | Cylinder shape planter |
| 19 | Pre-engineered barrier form |
| 20 | Concrete back fill |
| 21 | Planting medium |
| 22 | Square shape planter |
| 23 | Rectangular shape planter |
| 24 | Curved lip |
| 25 | Bull nose |
| 26 | Semi-sloped surface |
| 27 | Rebar caging |
| 28 | Base toe |
| 29 | Narrow upward portion |
| 30 | Base toe return |
| 31 | Sloping wall portion |
| 32 | Top opening |
| 33 | Bottom opening |
| 34 | Cross member rebar |
| 35 | L-shaped vertical rebar |
| 36 | Horizontal rebar |
| 37 | Radius tip |
| 38 | Recessed base |
| 39 | Extended Round tip |
| 40 | Collared neck |
| 41 | Reversed slope |
| 42 | Rounded tip |
| 43 | Reveal |
| 44 | Extended curve |
| 45 | Concave |
| 46 | Round base |
| 47 | Convex |
| 48 | Glass fibers |

### DETAILED DESCRIPTION

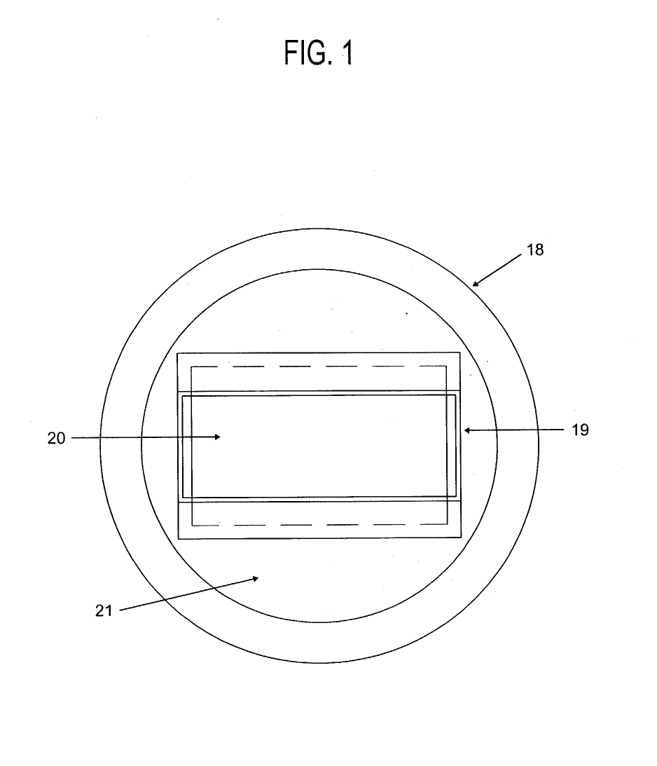

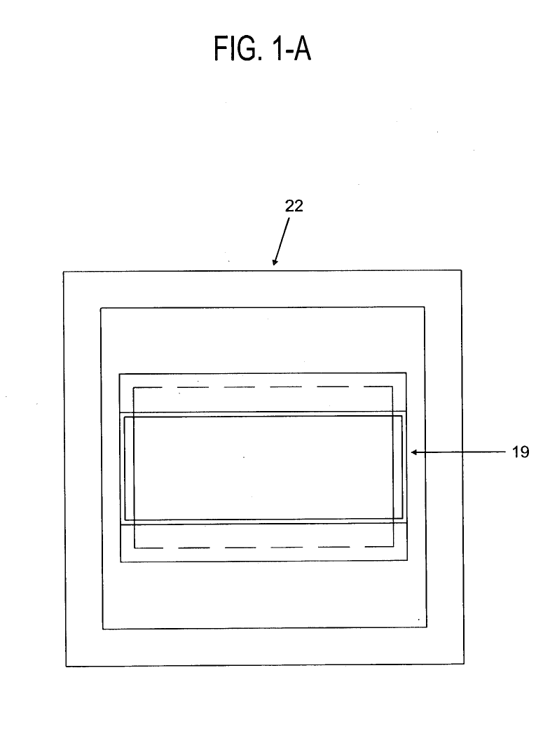

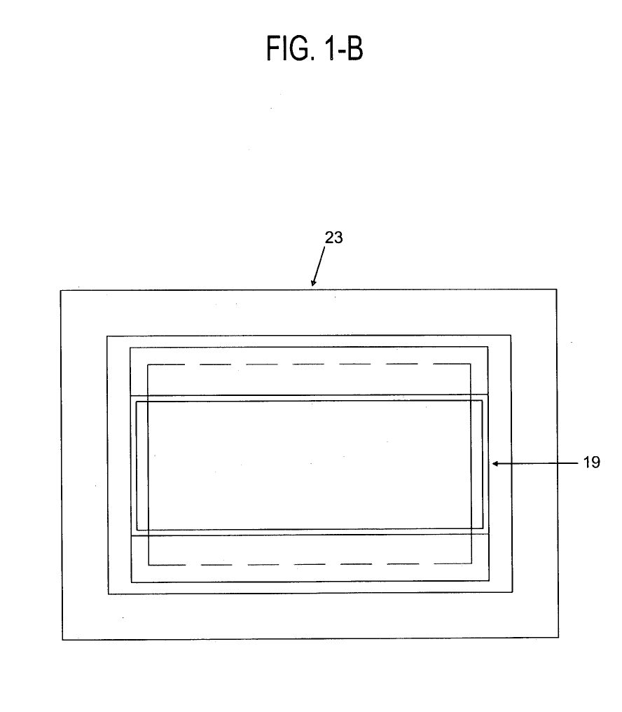

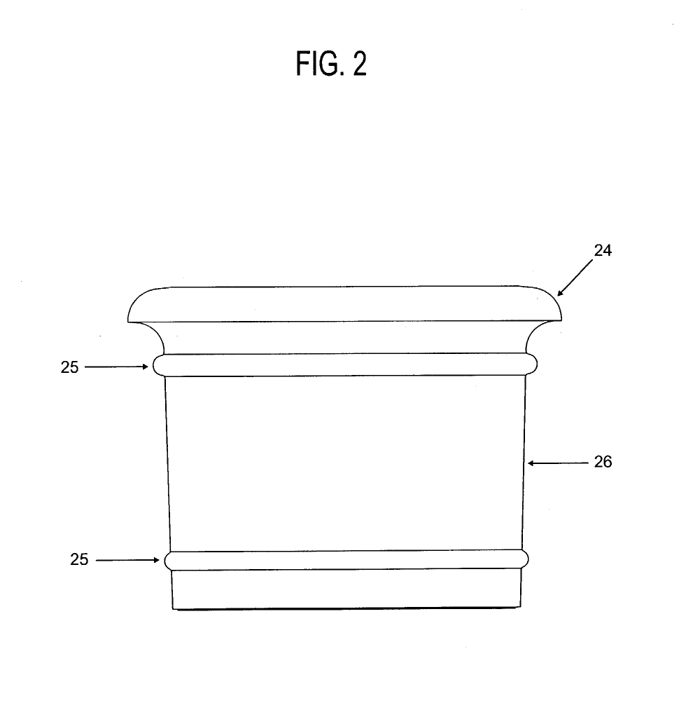

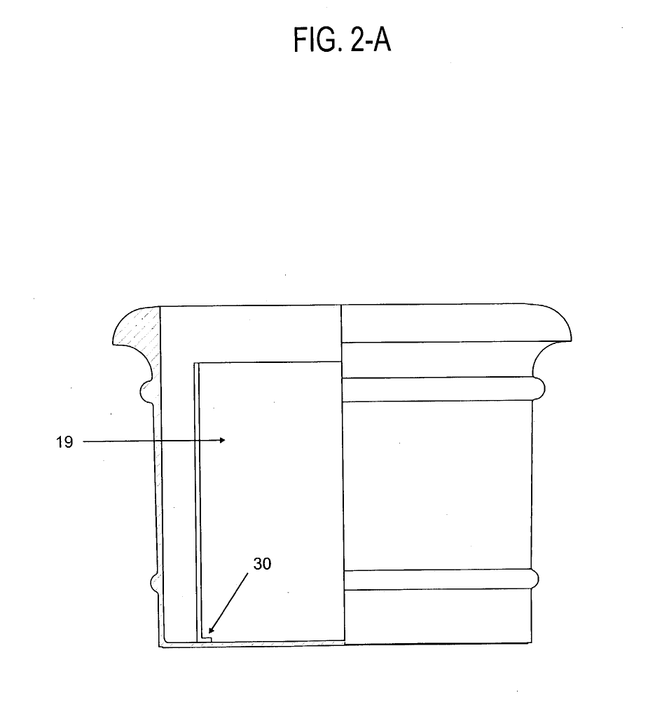

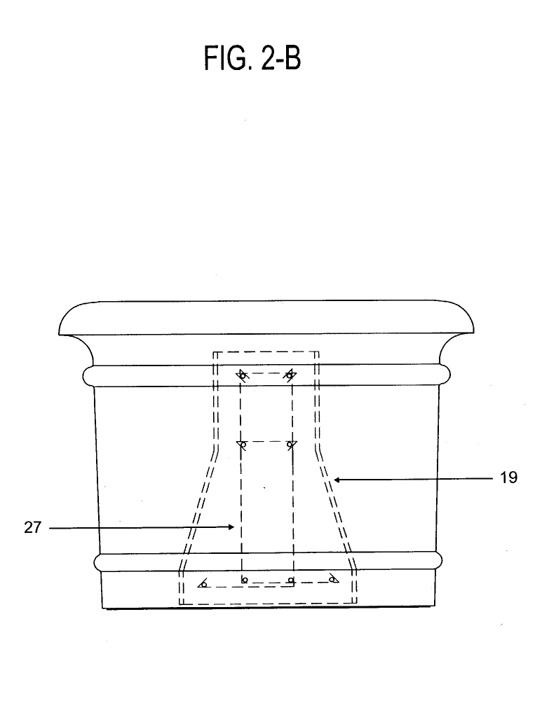

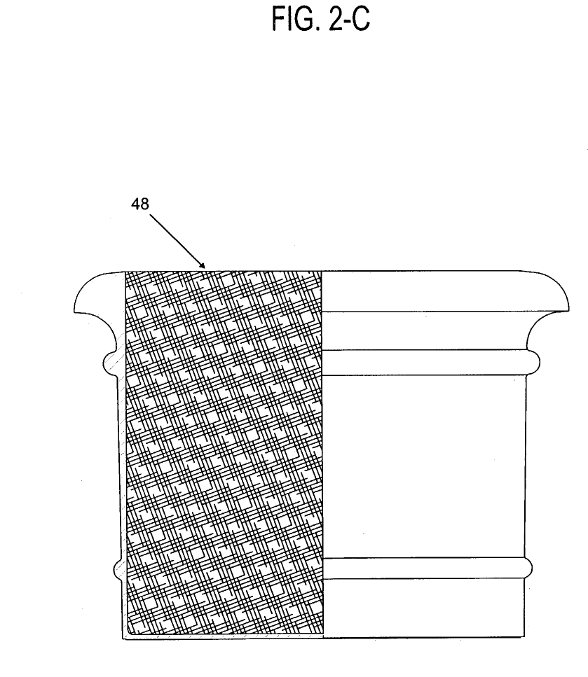

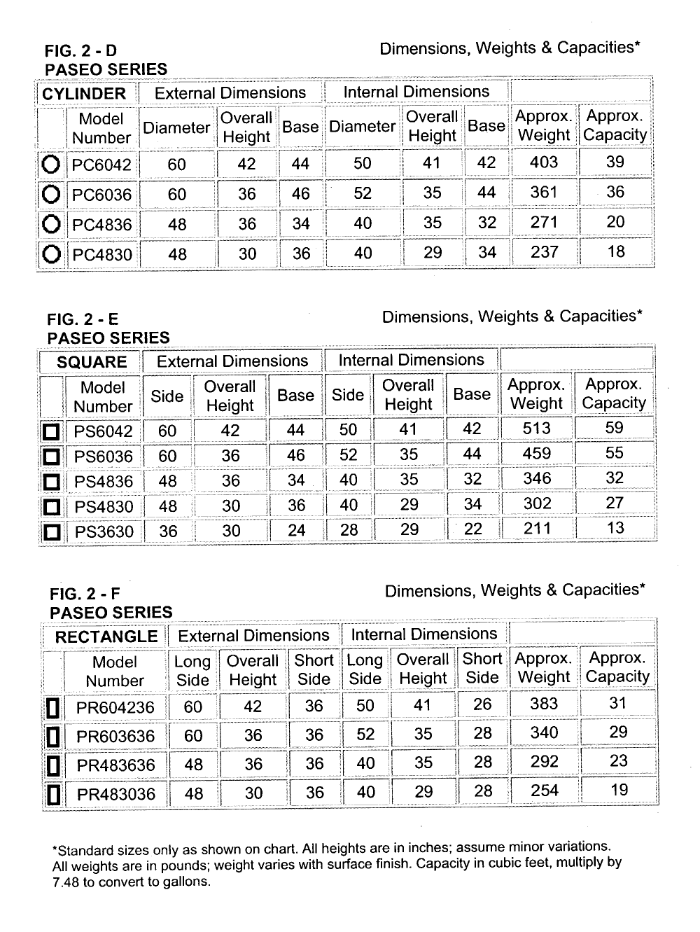

This relates to lightweight protective and decorative planter barricades made of glass fiber reinforced concrete with pre-engineered barrier form and steel rebar caging. A typical embodiment of the present invention is illustrated in FIGS. 1 and 2. To present a barricade system consisting of decorative planter elements with a variety of three-dimensional shapes and sizes, tables of dimensions were integrated in the drawings according to cylinder, square and rectangle designs.

FIGS. 1, 1-A and 1-B presents a basic plan of a barrier enclosed in cylindrical 18, square 22 and rectangular 23 planters. A pre-engineered barrier form 19 is built-in to any shape of planter with three-dimensional surface design demonstrated in FIG. 2. A preferred embodiment shows a semi-sloped planter 26 that has a narrow base and curved lip 24 opening accentuated by an upper and lower bull nose 25 designs. This drawing is identified as the ‘Paseo’ series. Applicable dimensions are shown in table form by FIGS. 2-D, 2-E and 2-F.

FIG. 2-A reveals a section view showing a partial elevation 19 of the barrier form that is lower than the curved lip opening 24. From another direction, FIG. 2-B displays a planter barricade with the end-side of the barrier form and rebar caging 27 represented in broken lines.

The novel characteristic of this invention is found on its unique material that holds the composite elements together because of glass fibers 48 randomly laid within the material matrix illustrated in FIG. 2-C. The result is a composite that combines the strength and lightweight characteristics of conventional fiberglass with the durability and longevity of cast stone.

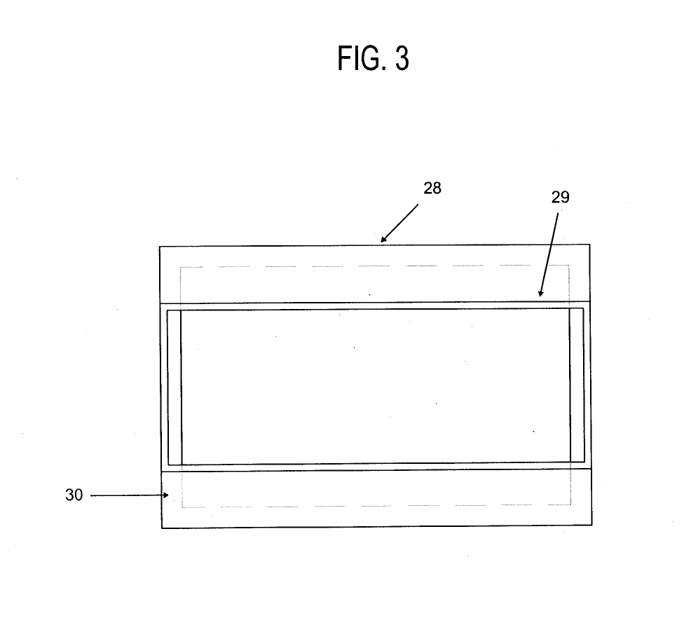

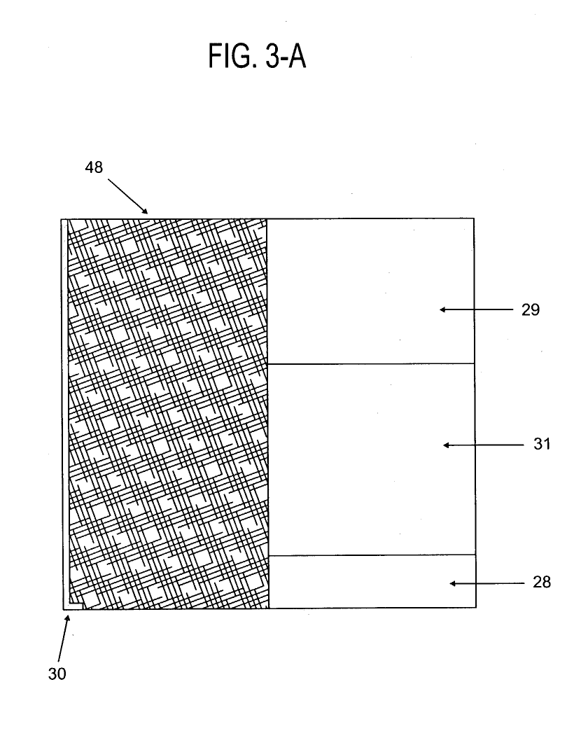

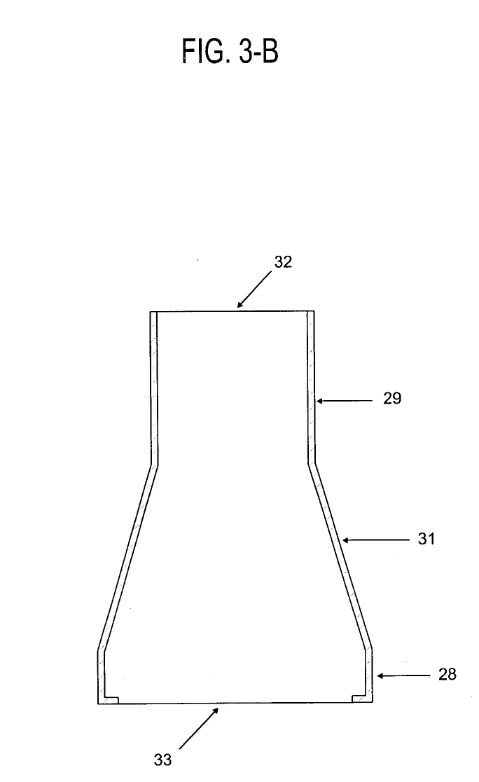

A pre-engineered barrier form similarly made from glass fiber reinforced concrete 48 is demonstrated in FIG. 3-A. FIG. 3 is a plan view that shows a base toe portion 28 preferably 20.5 inches wide, in contrast to an upwardly narrow wall portion 29 (FIG. 3-B) about 8.25 less, or preferably 12.25 inches in width. From the top opening, a base return 30 can be seen which serves as footing around the four sides of a rectangular form.

The barrier is again illustrated in FIG. 3-A which is a partial elevation showing the upward narrow portion 29 and a sloping wall portion 31 estimated about 70-80 degrees from the wide base portion 28. Total height of the barrier form is preferably 29.5 inches.

Using FIG. 3-B, the barrier form can be readily understood by a person knowledgeable in the art. Numeral 32 provides a top opening intended for back fill of graded cement and rock aggregates down to a similarly open bottom portion 33 for purposes of contact to the ground. Optional metal pin dowels may be employed as added reinforcement. Unlike conventional Jersey shaped barrier, this barrier form is an improvement to prior art in that it has a hollow internal structure that accommodates standard PSBS rebar design, making it easier to transport and install. FIG. 3-C is an end-side section of the barrier form exposing the rebar caging 27.

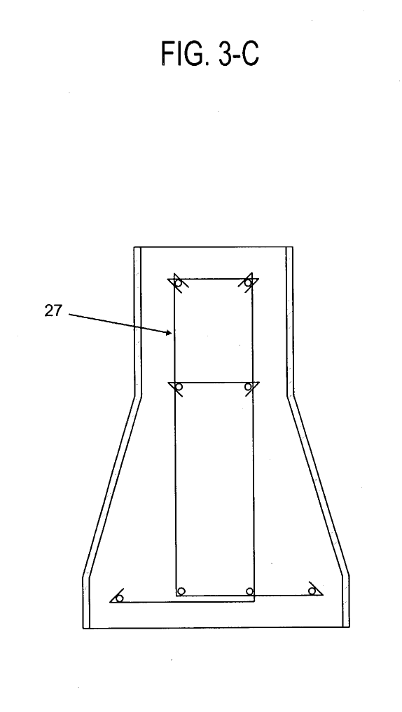

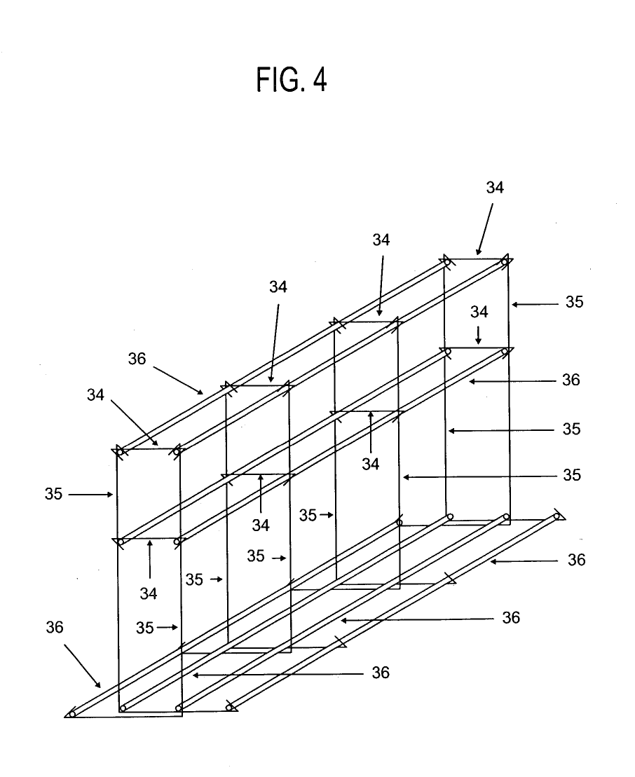

To illustrate the central part occupying the hallow structure of the barrier, FIG. 4 presents, in isometric view, a rebar design showing a plurality of L-shaped 35 standard grade steel bars attached to a series of cross-members 34 from the top and mid portion. The vertical L-shaped bars 35 are assembled in face-to-face position slightly over-lapping in the center of the lower portion providing an L-shape assembly. The L-shaped assembly are then arranged along a path of defining steel members consisting of horizontal rebar placed in side-by-side position from the base parallel to a similarly defining steel members above from the mid and top portion adjoining the cross-members 34.

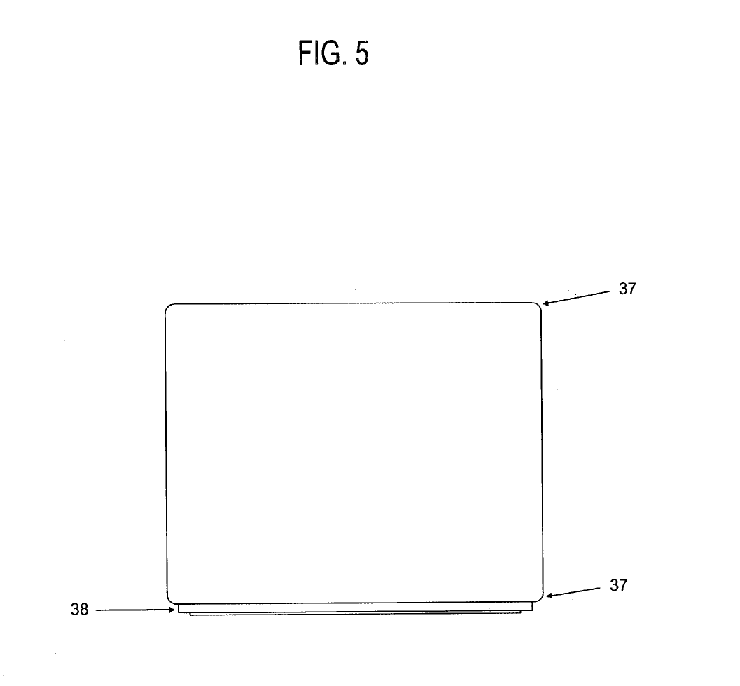

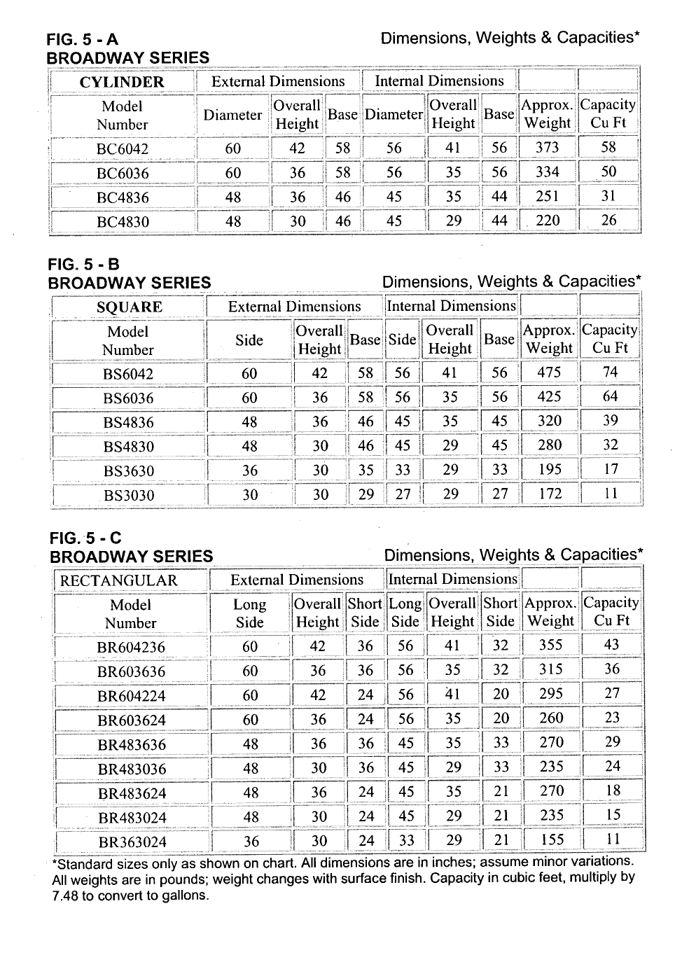

FIG. 5 is an alternative PSBS design identified as the Broadway series. This planter barricade consists of a radius tip 37 on the upper and bottom portion with a plain and straight surface wall positioned over a recessed base 38 footing. Variations of preferred shape, size and height are shown in the tables—FIGS. 5-A, 5-B, and 5-C.

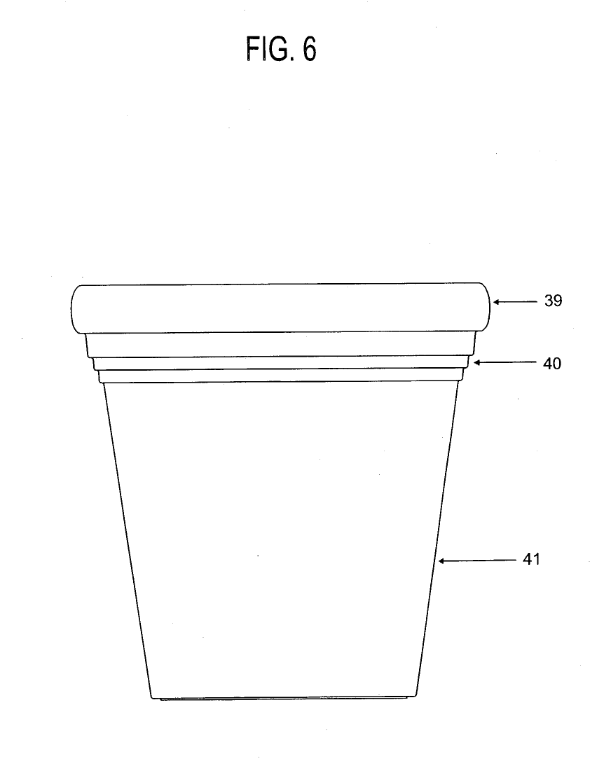

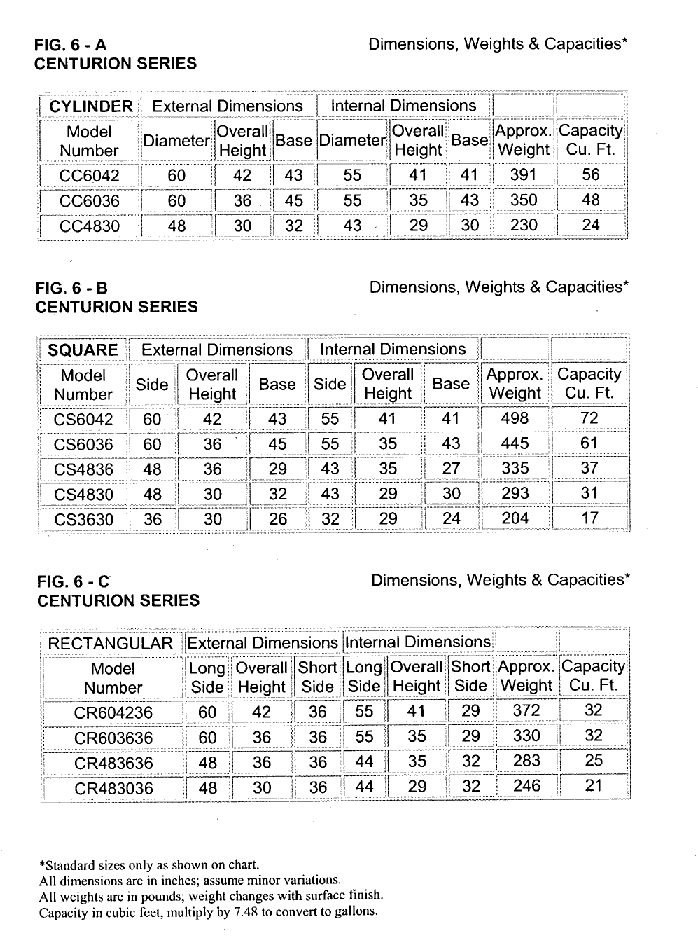

FIG. 6 is an alternative PSBS design identified as the Centurion series. This planter barricade has a narrow base and reverse slope 41 surface with an extended round tip 39 lip that has a wider opening followed by a collared neck 40 design directly below the extended round tip portion. Variations of preferred shape, size and height are shown in the tables—FIGS. 6-A, 6-B, and 6-C.

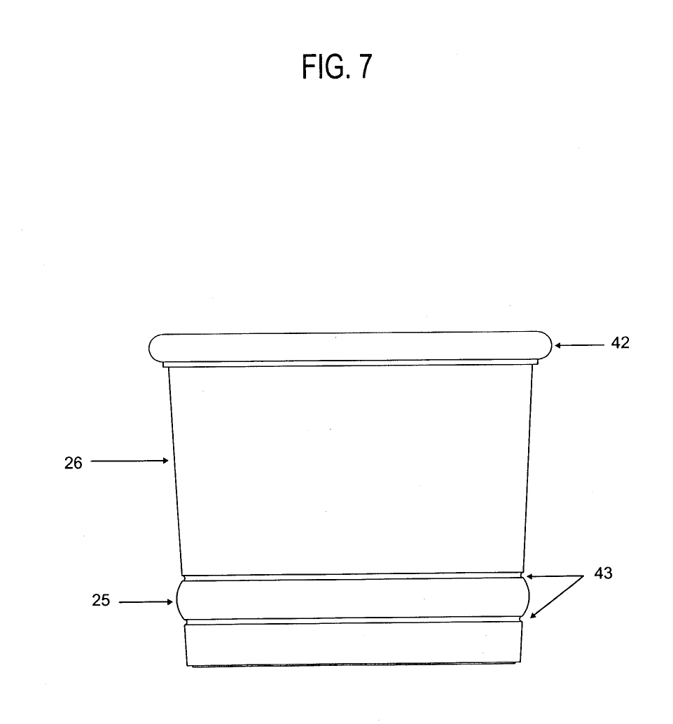

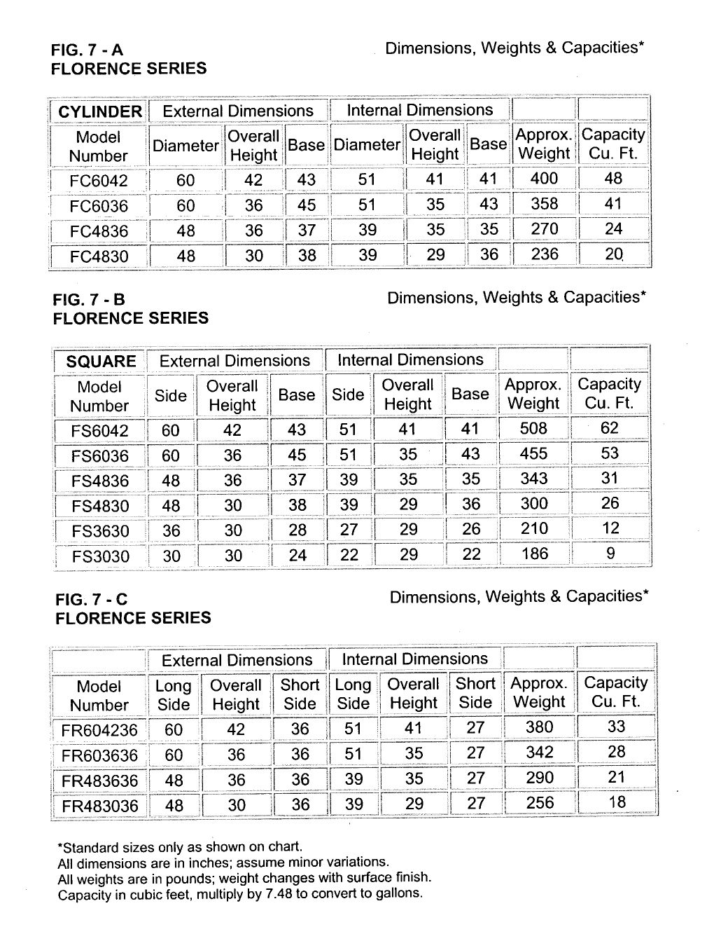

FIG. 7 is an alternative PSBS design identified as the Florence series. This planter barricade has a prominent bull nose 25 design found in the lower portion slightly above the base situated between two reveal 43. It has a rounded tip 42 lip with a single collar adjacent below. Variations of preferred shape, size and height are shown in the tables—FIGS. 7-A, 7-B, and 7-C.

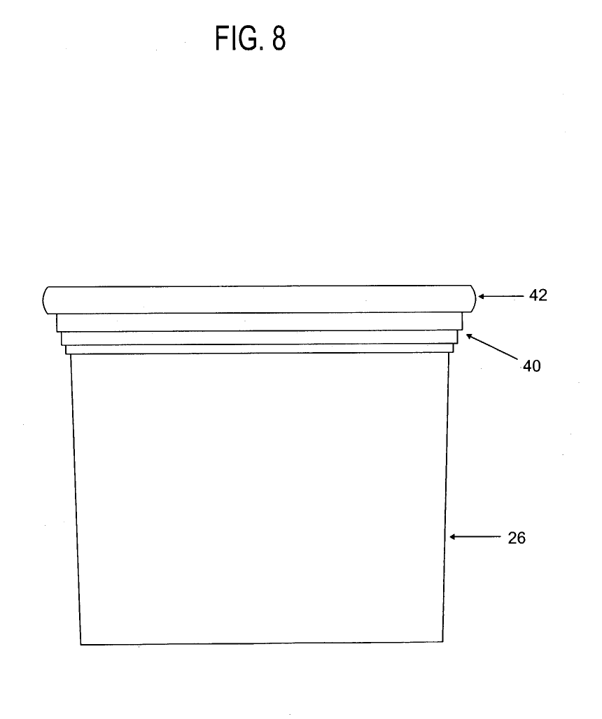

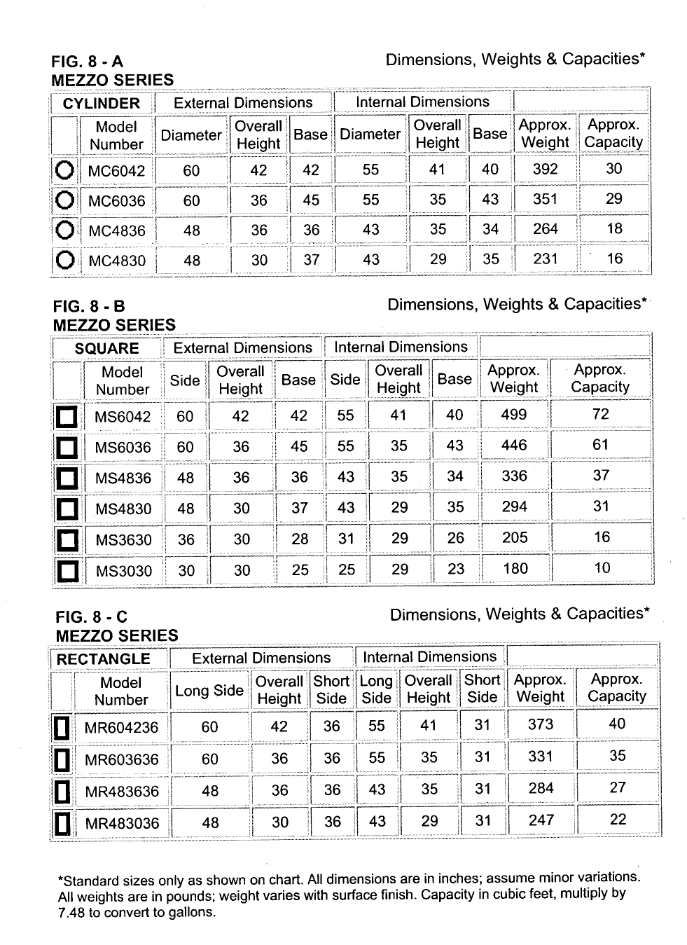

FIG. 8 is an alternative PSBS design identified as the Mezzo series. Having a plain facade with an extended round tip 42 lip, this planter barricade is comparable to the Centurion except for its semi-sloped 26 surface, giving it a wider base and sturdy profile. It also has collared neck 40 design adjacent under the tip. Variations of preferred shape, size and height are shown in the tables—FIGS. 8-A, 8-B, and 8-C.

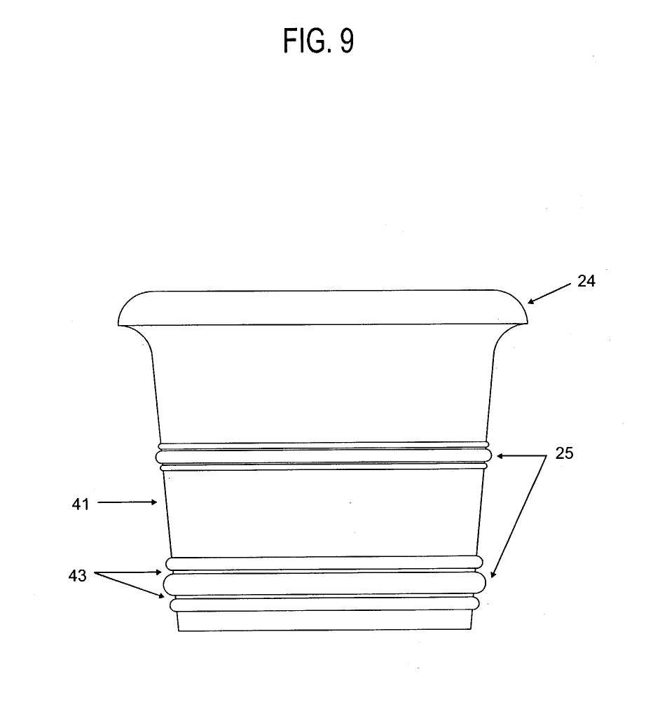

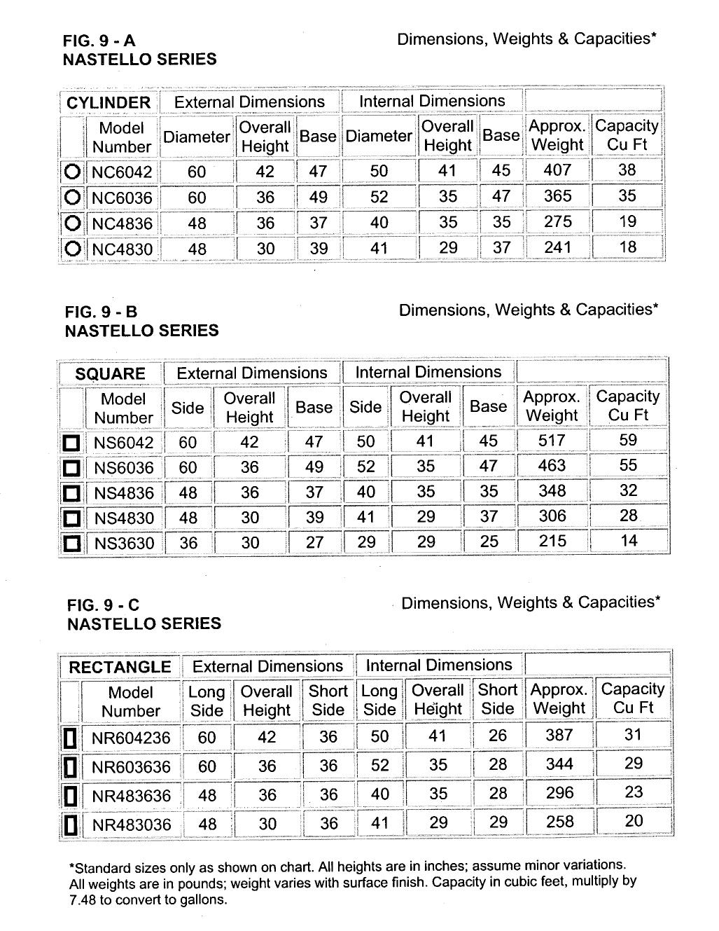

FIG. 9 is an alternative PSBS design identified as the Nastello series. This planter barricade consist of an upper curved lip 24 portion with a sequence of medium and large bull nose 25 designs accentuating a reversed sloped planter exterior in the middle and base portion. Variations of preferred shape, size and height are shown in the tables—FIGS. 9-A, 9-B, and 9-C.

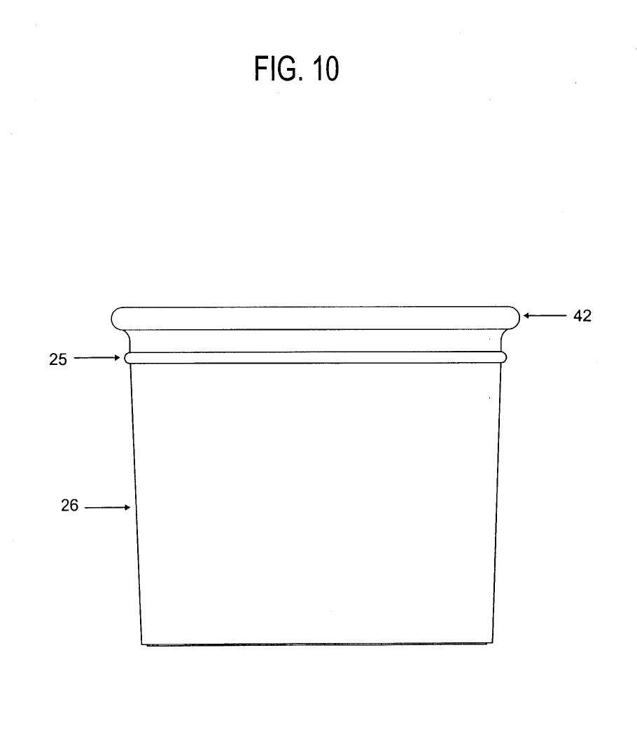

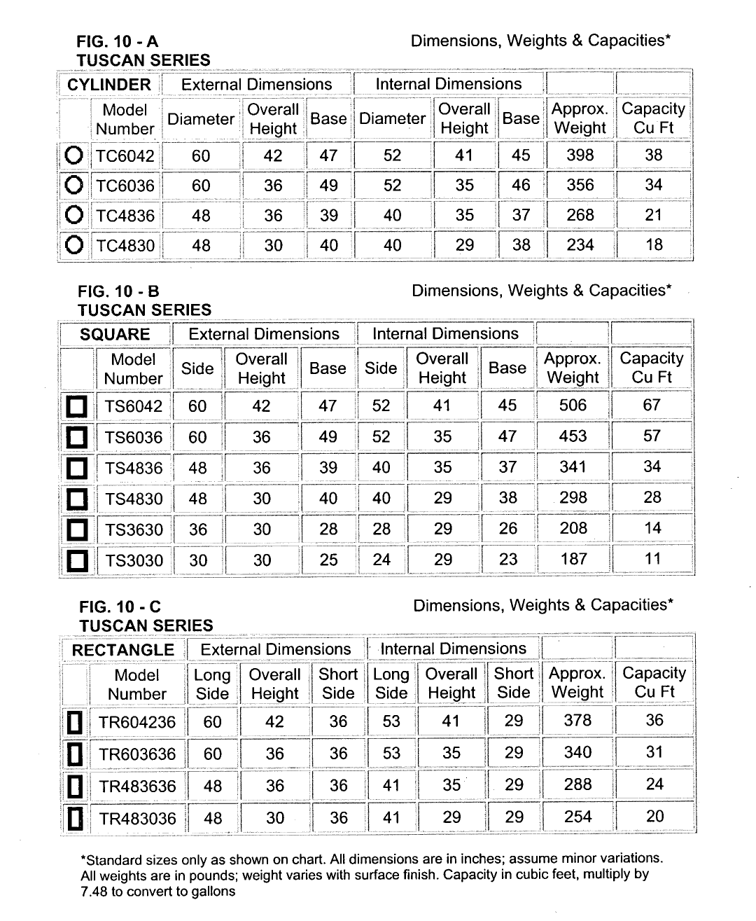

FIG. 10 is an alternative PSBS design identified as the Tuscan series. This planter barricade consists of a rounded tip 42 lip adjacent to a single bull nose 25 design directly below followed by a plain semi-sloped facade 26 from the neckline down to the base. Variations of preferred shape, size and height are shown in the tables—FIGS. 10-A, 10-B, and 10-C.

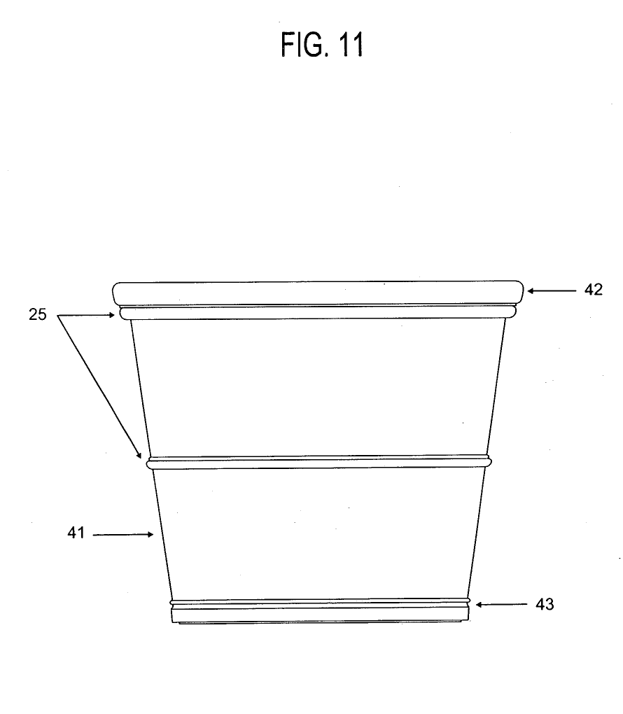

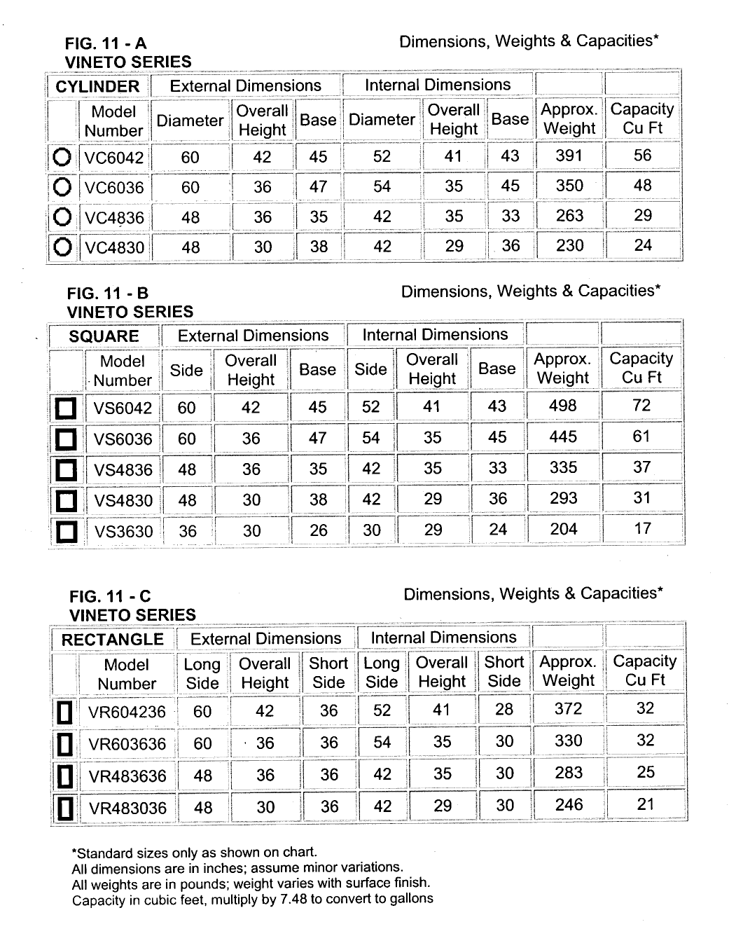

FIG. 11 is an alternative PSBS design identified as the Veneto series. This planter barricade consists of a reversed slope 41 exterior wall having a narrow base with reveal 43, expanding upwardly towards a middle and upper bull nose design and a wide rounded tip 42 portion. Variations of preferred shape, size and height are shown in the tables—FIGS. 11-A, 11-B, and 11-C.

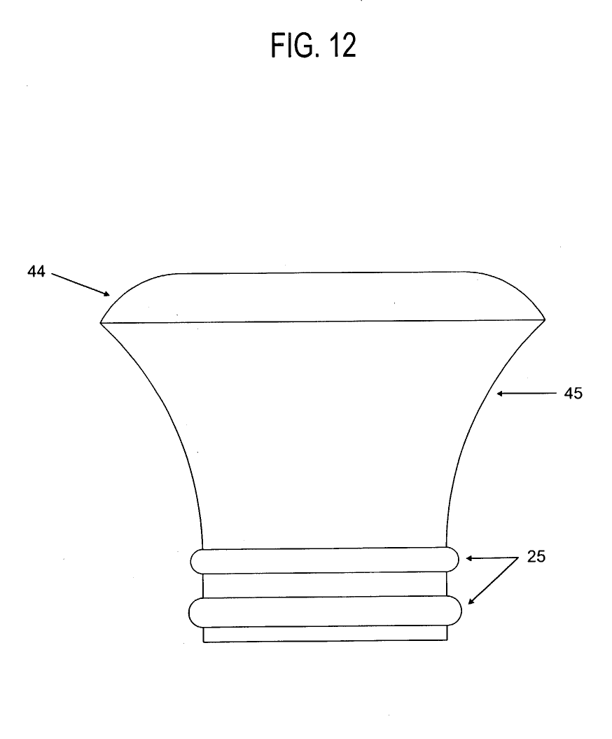

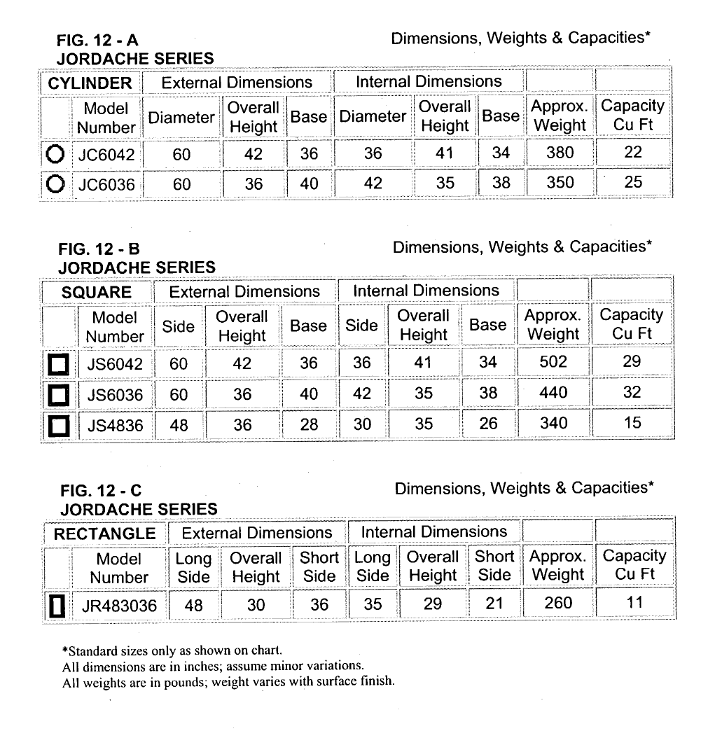

FIG. 12 is an alternative PSBS design identified as the Jordache series. This planter barricade has a concave 45 surface design extending upwardly and wide, capped with an extended curve 44 lip and accentuated with a double bull nose 25 from the lower narrow portion. Variations of preferred shape, size and height are shown in the tables—FIGS. 12-A, 12-B, and 12-C.

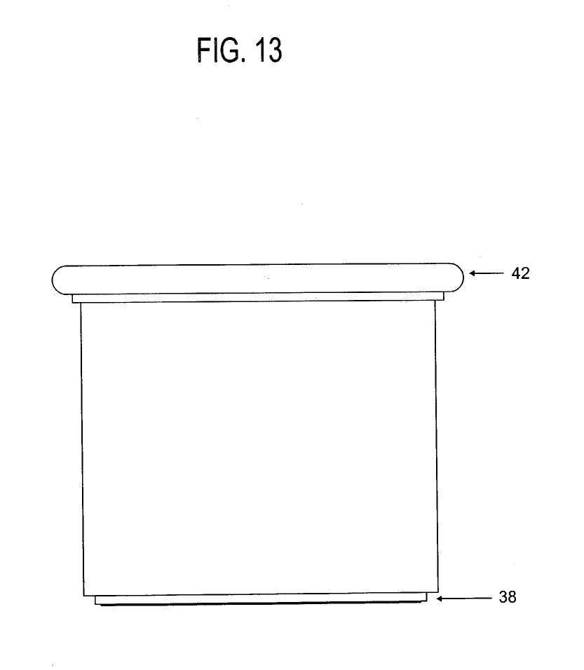

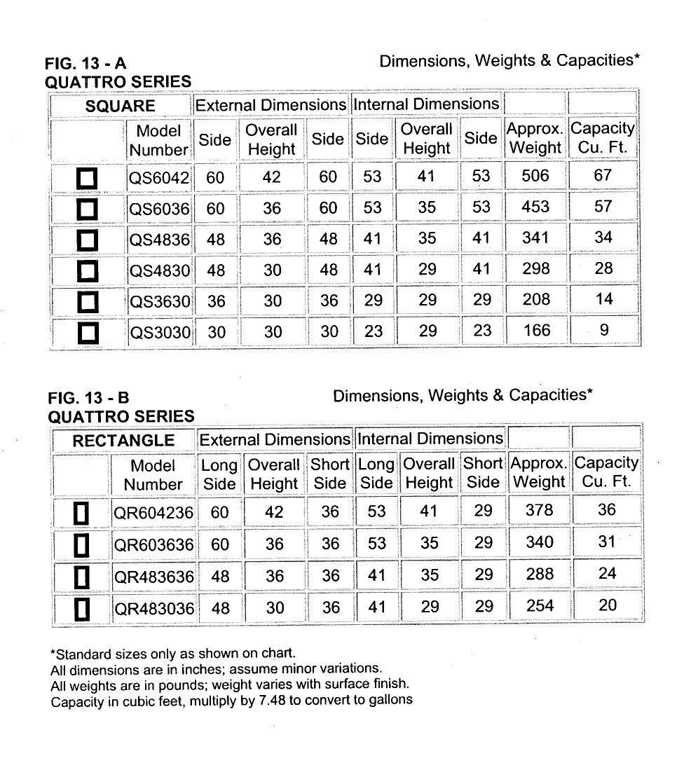

FIG. 13 is an alternative PSBS design identified as the Quattro series. This planter barricade consists of a rounded tip 42 lip adjacent to a single collar design below followed by a straight and plain surface wall from the neckline down to the lower portion supported by a recessed base 38. Variations of preferred shape, size and height are shown in the tables—FIGS. 13-A and 13-B.

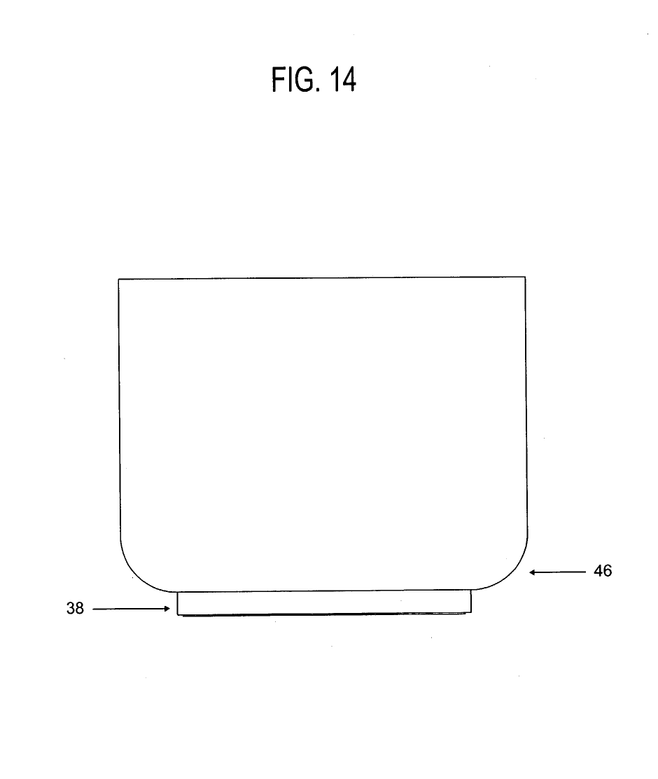

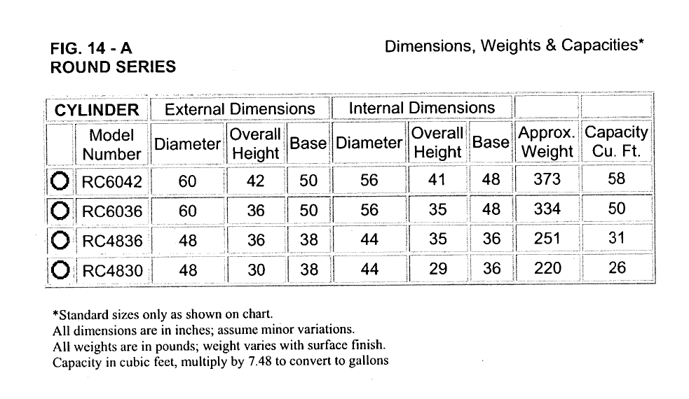

FIG. 14 is an alternative PSBS design identified as the Round series. This planter barricade consists of a plain upper rim and surface walling with a round base 46 portion situated over a recessed base 38. Variations of preferred shape, size and height are shown in the table—FIGS. 14-A.

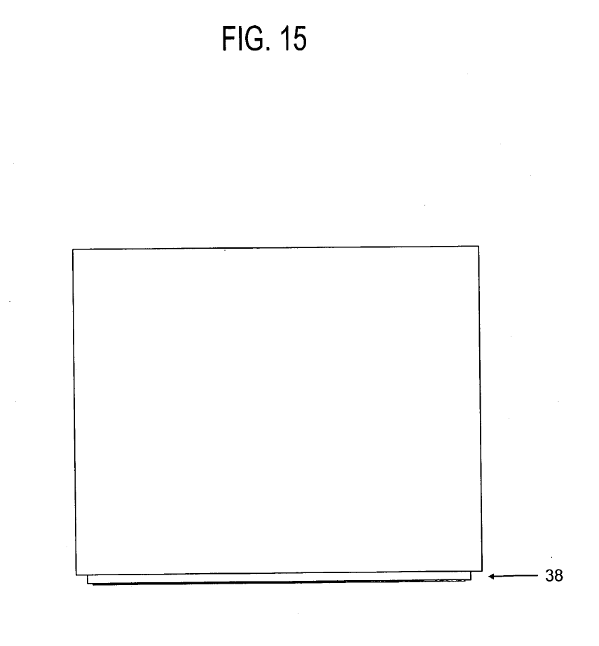

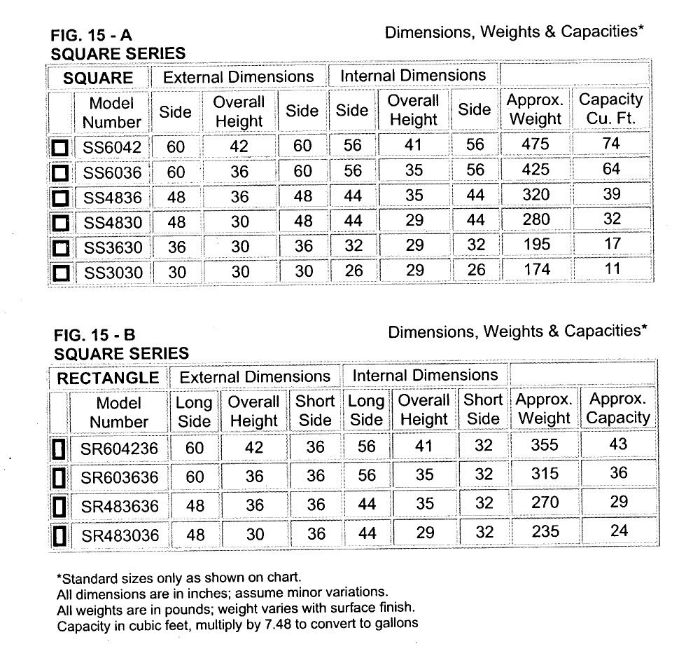

FIG. 15 is an alternative PSBS design identified as the Square series. This planter barricade consists of straight square edged upper and lower rim with a plain surface walling supported by a recessed base 38. Variations of preferred shape, size and height are shown in the tables—FIGS. 15-A and 15-B.

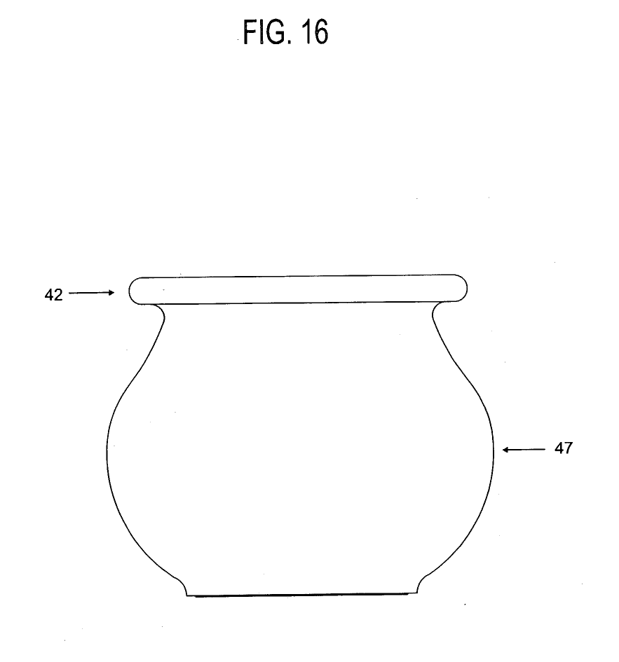

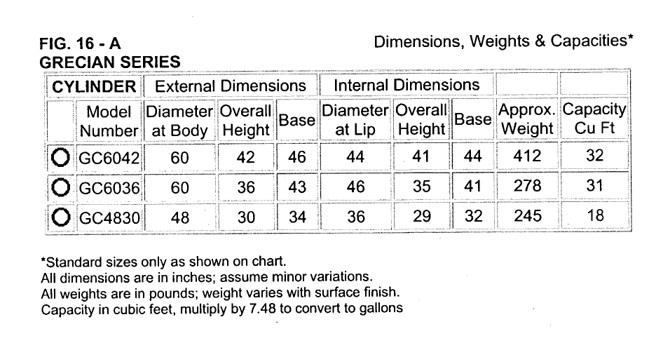

FIG. 16 is an alternative PSBS design identified as the Grecian series. This planter barricade consists of a rounded tip 42 lip with a convex 47 exterior outwardly protruding between a narrow base and a contoured neck, providing for its bulging look. Variations of preferred shape, size and height are shown in the table—FIGS. 16-A.

What is claimed is:

1. A planter barricade system, comprising of:
an outer planter shell made of composite cement and graded stone embedded with strands of glass fibers;
a pre-engineered barrier form that has an upwardly extending narrow wall portion and a wide base lower portion;
a standard rebar caging design consisting of a plurality of L-shaped standard grade steel rebar assembled to a cross-member from the top and middle portion.

2. An outer planter shell according to claim 1 wherein the planter is categorized according to cylindrical, square and rectangular shapes;
a planter categorized into cylindrical, square and rectangular shapes wherein each category of shape is further classified into series of designs;
a planter classified into series of designs wherein each series is identified as a distinct planter;
a series of planters identified as follows: Broadway, Centurion, Florence, Mezzo, Nastello, Paseo, Tuscan, Veneto, Jordache, Quattro, Round, Square and Grecian.

3. A pre-engineered barrier form according to claim 1 wherein the barrier form is made of composite cement and graded stone embedded with strands of glass fibers;
a barrier form wherein the wide base portion consist of a base toe extending sideward preferably 20.5 inches wide calculated from the short side and an upwardly narrow wall portion preferably 12.25 inches in width calculated from the short side;
a barrier form wherein the narrow wall portion is adjacent to an open top section;
a barrier form wherein the wide base portion is adjacent to a similarly open bottom section;
a barrier form that has an upwardly extending narrow portion and a wide base lower portion wherein the wall section in between is sloped about 70-80 degrees from the wide base portion;
a barrier form that has a hollow internal structure that can accommodate a standard rebar caging design.

4. A standard rebar caging design consisting of a plurality of L-shaped steel rebar wherein the L-shaped bars are assembled in face-to-face position over-lapping from the center of the lower portion and attached by means of cross members from the top and middle portion;
a rebar caging assembled in face-to-face position by mean of cross members wherein the L-shaped assembly are arranged along a path of defining steel members consisting of horizontal rebar placed in side-by-side position from the base parallel to a similarly defining steel members above the top and middle portion adjoined by a series of cross-members.
